(19) United States
(12) Patent Application Publication
(10) Pub. No.: US 2005/0062026 A1
(43) Pub. Date: Mar. 24, 2005

(54) Roofers tool

(76) Inventor: Steve Wayne Holcomb, Friday Harbor, WA (US)

Correspondence Address: STEVE HOLCOMB, P.O. BOX 695, FRIDAY HARBOR, WA, 98250, US

(21) Appl. No.: 10/667,993

(22) Filed: Sep. 23, 2003

(51) Int. Cl. B66F 15/00

(52) U.S. Cl. 254/25

(57) ABSTRACT

A roofers staple puller comprises a substantially flat bar with integrally formed U-shape prying foot provided with a plurality of fingers arranged for the removal of roofing staples and nails of varying geometry at one end of the longitudinal axis, a prying surface substantially notched to facilitate the removal of longer nails and spikes at the opposite end and an integral generally diamond shaped puller arranged for the removal of longer nails or spikes located there between.

### BACKGROUND OF THE INVENTION

1. Field of Invention

This invention relates generally to hand tools and, more specifically to an improved roofers tool with a geometry allowing for the removal of a plurality of sizes of roofing staples as well as conventional roofing nails and spikes.

2. Description of Prior Art

In replacement of roofing on homes or other dwellings it is most common to remove the old worn out shingles or composition material from the roof prior to installing a new covering. This procedure is often necessary to allow inspection of the under structure of the roof beneath the roofing while providing for a clean flat surface for installation of the new roof covering. The removal of the older roofing material is usually tedious and time consuming due to the fact that the older worn out roofing materials have a tendency to break apart where fastenings secured them in place leaving the nails or staples that held it in place tightly lodged in the under structure. Due to the fact that the old nails or staples protruding from the roof surface will damage the new materials when installed, it is imperative that the old fasteners be removed.

A number of utility tools have been developed and used over the years to facilitate the removal of old roofing nails and staples ranging from simple crow bars to carpenters hammers. Generally however, the tools were primarily suited to extracting nail type roofing fasteners. As it has been more common in recent years to utilize the easier applied staples in place of nails, the more conventional tools which were designed primarily for nail pulling have proven to be less effective on roofing staples requiring the roofer to use additional tools such as small pry bars, pliers and in some cases, even modified straight slot or flat bladed screw drivers. Generally, the method for removing the nails and staples has been to use anything that can be wedged under the fastener and operates on the principal of a first class lever wherein the load is at or near one end of the prying tool and the effort of force is applied to the other end with a fulcrum or pivot point located somewhere between the load and the effort. Tools like the pry bar or “Utility bar” as outlined in Khachatoorian's Pat. No. 6,257,553 have been used over the years for this purpose. Although this tool accommodates nails quite well, it is of little use for removing staples as the configuration of the puller is arranged to accommodate primarily, common nails with heads. There are tools that have been designed more specifically for pulling staples as outlined in Rochefords “Staple removing tool” U.S. Pat. No. 6,308,935, Brumfield's “Staple remover” U.S. Pat. No. 4,219,187 or Thurmston's “Staple and tack extractor” U.S. Pat. No. 5,031,881. They are however substantially less rugged than needed for the heavier roofing fasteners, and intended more for use on furniture reupholstering or removing staples from cardboard boxes. These tools are intended primarily for the removal of staples only and are not generally designed or intended for nail extraction.

There are also a number of more expensive and complex pullers that have been introduced in recent years that function very much like standard pliers. Pearson's “Shake nail puller” U.S. Pat. No. 4,798,366, Henning's “Nail puller” U.S. Pat. No. 4,997,163. or Johnston's “Staple removal tool” U.S. Pat. No. 5,996,969 are of a design that utilizes a set of jaws actuated by a squeeze grip either grabbing the staple on it's outside geometry or sliding under the bridge portion of the staple whereby using a rocking or prying motion of the tool, can extract the staple. In review of the above referenced patents we can see that there are a number of tools that will remove nails as well as some innovative designs that address the removal of staples. A single simple tool as outlined in the following summary however, designed with the versatility to pull long nails, short nails and a plurality of standard staple sizes could greatly simplify the “removal of the old roofing and staples” and greatly increase the efficiency of the re-roofing process.

### SUMMARY

Accordingly, it is an object of this invention to provide a universal staple and nail pulling tool that does not have the limited capability inherent in prior art pullers comprising a. simple pry bar design provisioned to remove a plurality of sizes of both roofing staples and roofing nails by incorporating in one tool a plurality of nail pulling details as well as a prying foot arranged with staple pulling fingers that will accommodate a plurality of standard staple sizes.

It is yet another object of this invention to provide additional nail and spike pulling capability for removing nails of extended length.

It is a further object of this invention to provide a staple and nail puller as described above with geometry allowing the user good visibility of the fasteners to be pulled. In order to achieve the above objectives, a universal roofers tool is provided. The universal roofers tool being comprised of a forged, tempered “L” shaped steel flat bar with integrally formed U-shaped prying foot and arranged with a plurality of staple pulling fingers for removing nails and staples of varying dimension on one end, and multiple means for removing larger and longer nails as may be required, in the mid section and opposite end of the universal tool.

The above advantages and subsequent detailed description will be more readily understood by reference to the following illustrations.

### DESCRIPTION OF THE DRAWINGS

A universal roofers tool embodying the features of the invention is illustrated in the following drawings forming part of this application, where in:

FIG. 1 is a perspective view of the universal roofers tool

FIG. 2a and 2b are side and front views respectively of the preferred embodiment of the universal roofers tool.

FIG. 3 is a prospective view of staple pulling finger details of universal roofers tool.

FIG. 3a is a side and front view respectively of optional staple pulling finger geometry.

FIG. 4 is a perspective view of universal roofers tool spike pulling detail and diamond notch nail puller.

FIG. 5 Is a side and ghost views of universal roofers tool referencing operation.

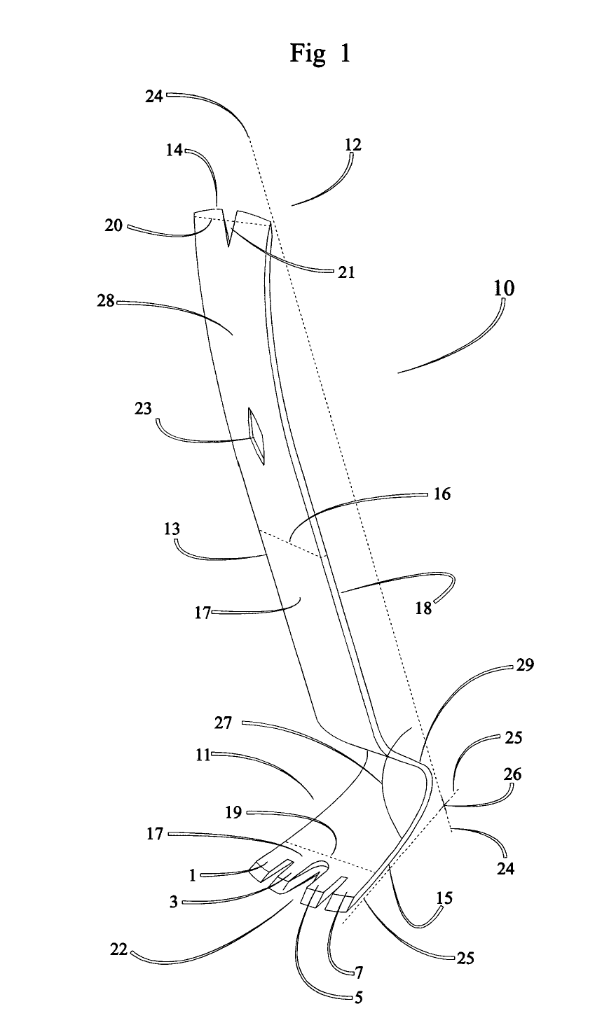

Referring now to FIGS. 1 through FIG. 5 in which identical parts are designated by the same reference numbers

Where in FIG. 1 shows a universal staple and nail pulling tool in accordance with the present invention herein referred to as tool 10 being comprised of an elongated flat steel bar whose main body will herein be referred to as the shank 13. Shank 13 cross section at mid section 16 being approximately 1¼″ wide and ¼″ in thickness having a front facing surface 17 and a back facing surface 18. A foot 11 defining the first end of the primary prying foot protrudes out in the direction of front surface 17 of shank 13, and grip end 12 defines a second end and a secondary prying surface. A large radius bend forming fulcrum 28 is formed in the direction of back surface 18 of shank 13 . Tool 10 is approximately 15″ in length measured from crown 14 on grip end 12 to base 15 of foot end 11. Foot end 11 and grip end 12 of Shank 13 to be substantially flared to approximately 1¾″ measured approximately at section 19 adjacent to staple puller fingers 1,3,5 and 7 on foot end 11 and at width 20 adjacent to crown 14 on grip end 12 of shank 13 on tool 10. Tool 10 to be provided for with a “V” groove spike and nail puller 21 substantially centered in crown 14 of grip end 12, an additional “V” groove nail puller 22 substantially centered between and integrated into geometry defining staple pulling fingers 3 and 5 on foot 11 of tool 10. A diamond notched nail puller 23 in shank 13 is provided for pulling nails or spikes of extended length.

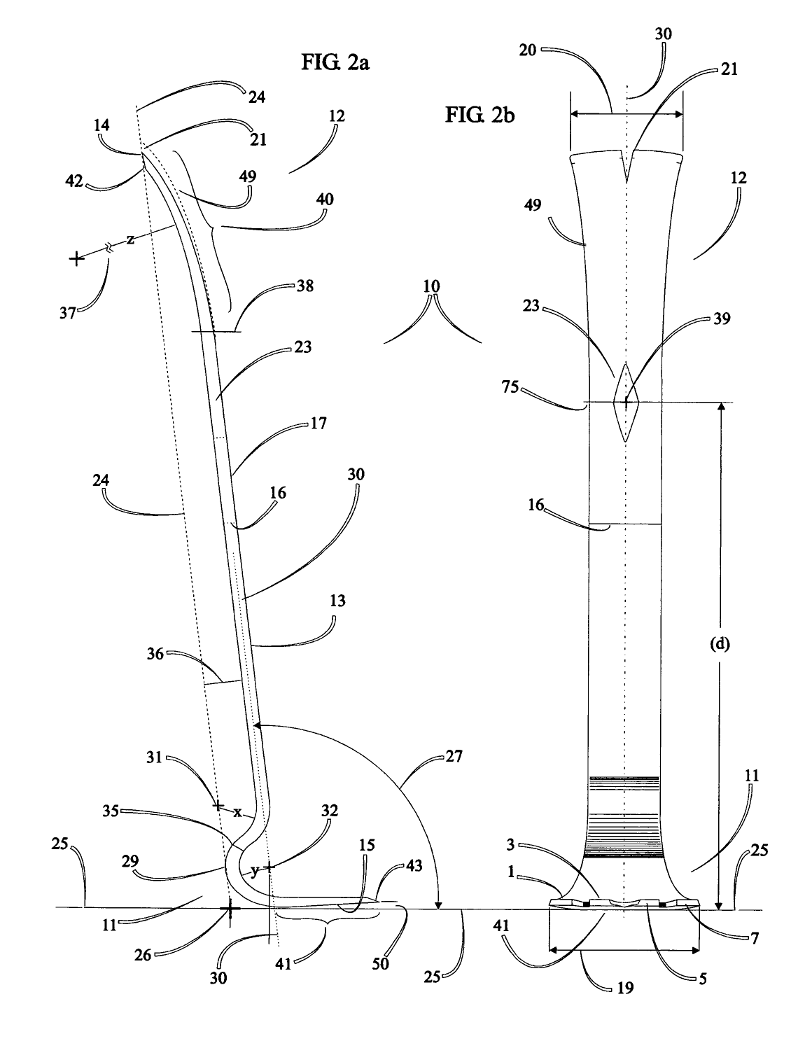

Major longitudinal dimension of tool 10 is substantially parallel to offset layout line 24 and centerline 30 (see FIG. 2b) of shank 13. Plane line 25 is parallel to base 15. Offset layout line 24 intersects with plain line 25 at intersect point 26 forming an approximate 97 degree angle 27 which defines the approximate “L” shape of tool 10. The integrally formed large radius bend in shank 13 provides a fulcrum 28 when tool 10 is utilized as a simple class one lever in conjunction with spike puller 21. Integrally formed rocker 29 on foot end 11 of tool 10 also allows tool 10 to function as a simple class one lever when implementing staple pulling fingers 1,3,5 an 7 or nail puller 22 on foot 11 end of tool 10. Tool 10 functions as a class two lever when diamond notch nail puller 23 in shank 13 of tool 10 is being utilized. Thus, tool 10 can be utilized in a plurality of ways for the purpose of gaining mechanical advantage when pulling or removing standard sizes of roofing staples as well as various sizes of roofing nails and spikes. Referring now to FIG. 2a and 2b further defining profile geometry of tool 10 wherein offset layout line 24 defines the major longitudinal axis of tool 10 and is substantially parallel to physical centerline 30 of shank 13, and base 15 on foot 11 of tool 10 is approximately parallel to plane line 25 and where offset layout line 24 and plane line 25 intersect at 26 to form angle 27 which is approximately 97 degrees and is provided to allow operator improved visibility of staple pulling foot 11 when tool 10 is in use. Rocker 29 is the fulcrum point for foot 11 and is generated at foot 11 of shank 13 by forming two opposing and intersecting 0.750″ radius “X” and “Y” into foot 11 of tool 10. Center point 31 for generating radius “X” is located substantially on offset layout line 24 a distance of 2″ from plane line 25. Center point 32 for generating radius “Y” is located substantially on physical centerline 30 of shank 13 approximately 1″ from plane line 25. Radius “Y” merges with radius “X” at point 35 and with base 15 at the point where base 15 of foot 11 of tool 10 is approximately parallel to plane line 25. The merging of directionally opposing Radius “X” and radius “Y” at point 35 provide rocker 29 with an approximate 1″ offset 36. Offset 36 of 1″ is the sum of shank 13 mid section 16 thickness of approximately 0.250″ and 0.750″ inside measurement of radius “Y”.

Continuing to reference FIG. 2a wherein radius “Z” 37 is integrally formed in grip end 12 of tool 10 Wherein Radius “Z” 37 is an Integral bend of approximately 9″ radius starting at point 38 on shank 13 of tool 10. Point 38 is approximately 10½″ from plane line 25.

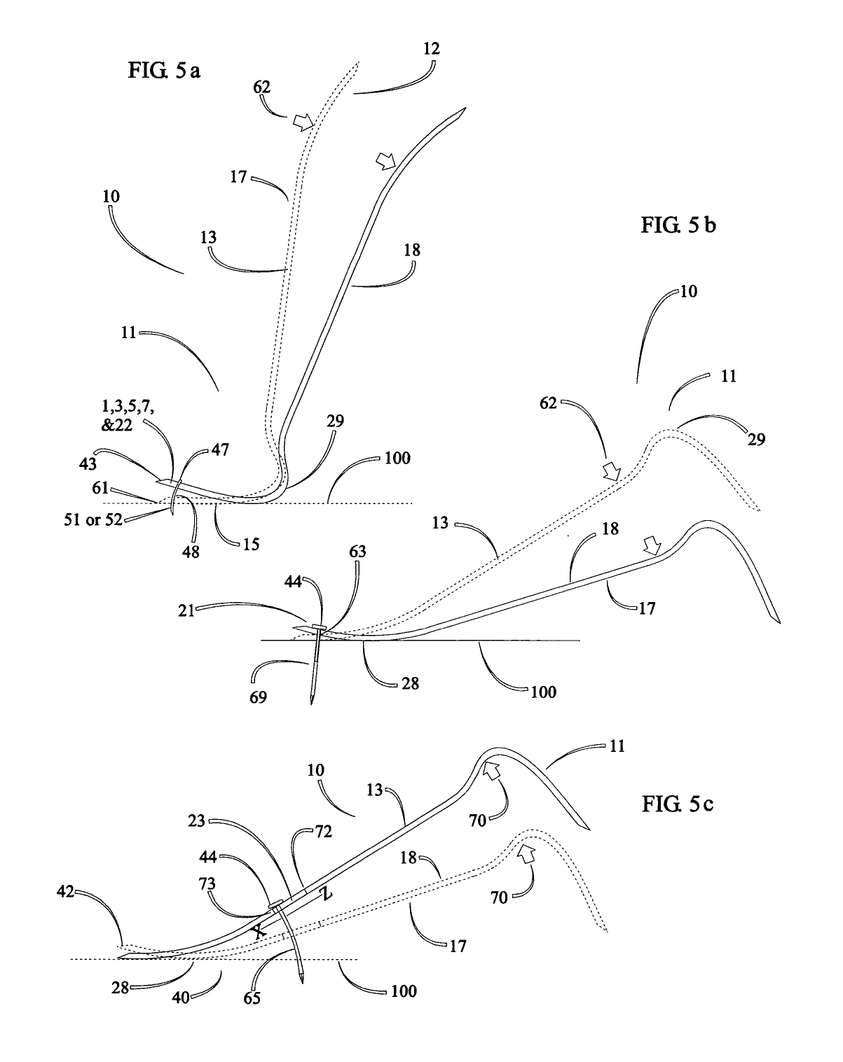

Radius “Z” 37 terminates at the point where crown 14 intersects with offset layout line 24. Radius “Z” 37 provides for fulcrum 28 (see FIG. 1) on front 17 of shank 13 of tool 10 and is used in conjunction with spike and nail puller 21 on grip end 12 of tool 10 and when utilizing diamond notched nail puller 23 in shank 13 of tool 10 as shown in FIG. 5 Refering now to FIG. 2b wherein a front view of tool 10 illustrates location of diamond notch nail puller 23 provided for pulling nails of extended length. Diamond notch nail puller 23 geometry is substantially centered in shank 13 of tool 10 with center 39 substantially located on minor axis 75 approximately 9½″ (d) from plane line 25.

Continuing to reference FIGS. 2a and 2b wherein the thickness of shank 13 foot print area 40 of fulcrum 28 on grip 12 end of tool 10 is diminished to approximately 50% 49 of it's original thickness utilizing a sanding or grinding process. Sanding or grinding process on footprint 40 area to start approximately at point 38 where radius “Z” 37 blends into straight section of shank 13 with material removal increased gradually from point 38 to crown 14 resulting in approximately 50% of the beginning thickness 16 of shank 13 at crown 14 of tool 10. The same grinding or sanding process to footprint area 41 for reducing the thickness of footprint area 41 of foot 11 on tool 10 to start approximately at centerline 30 where radius “Y” 32 blends into base 15 on foot 11 of tool 10 decreasing thickness of base 15 of tool 10 approximately 50% at beveled end 43 of staple pulling fingers 1,3,5 and 7 on base 15 of foot 11 of tool 10.

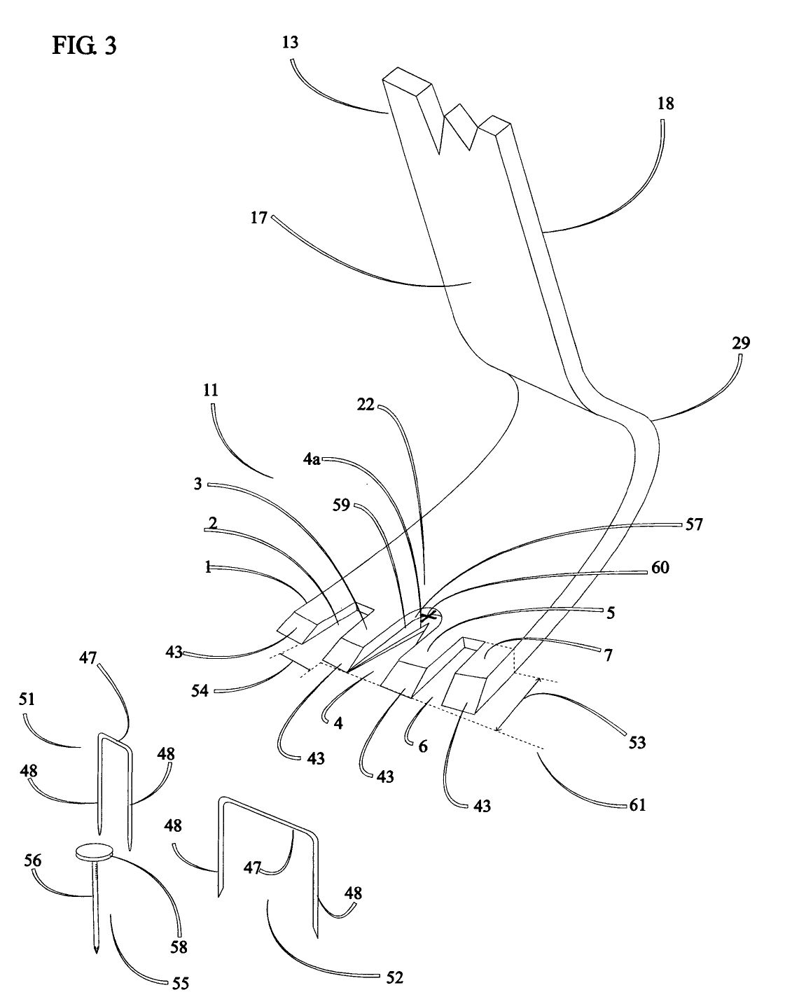

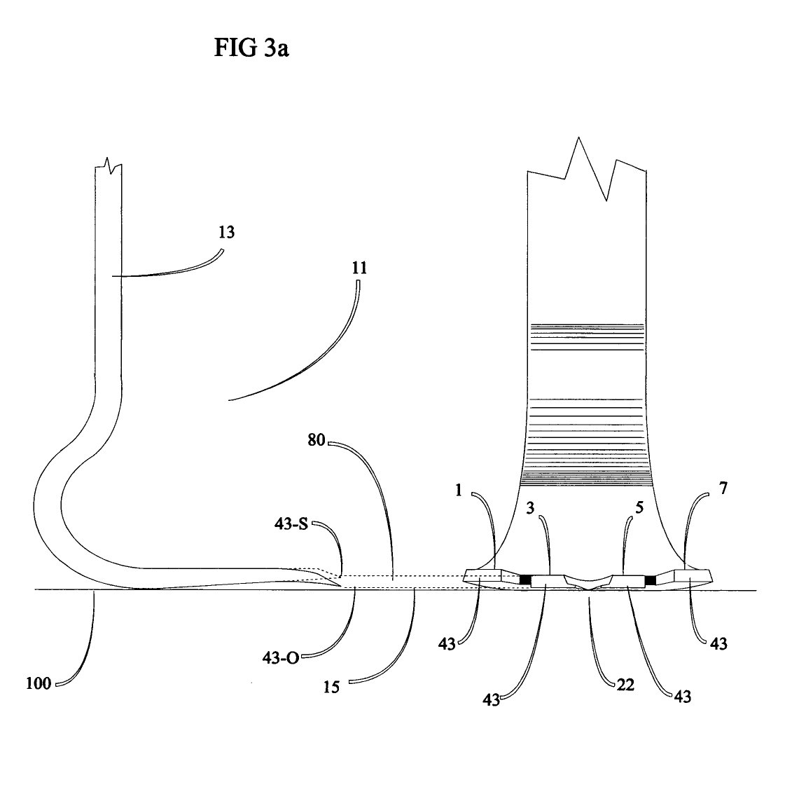

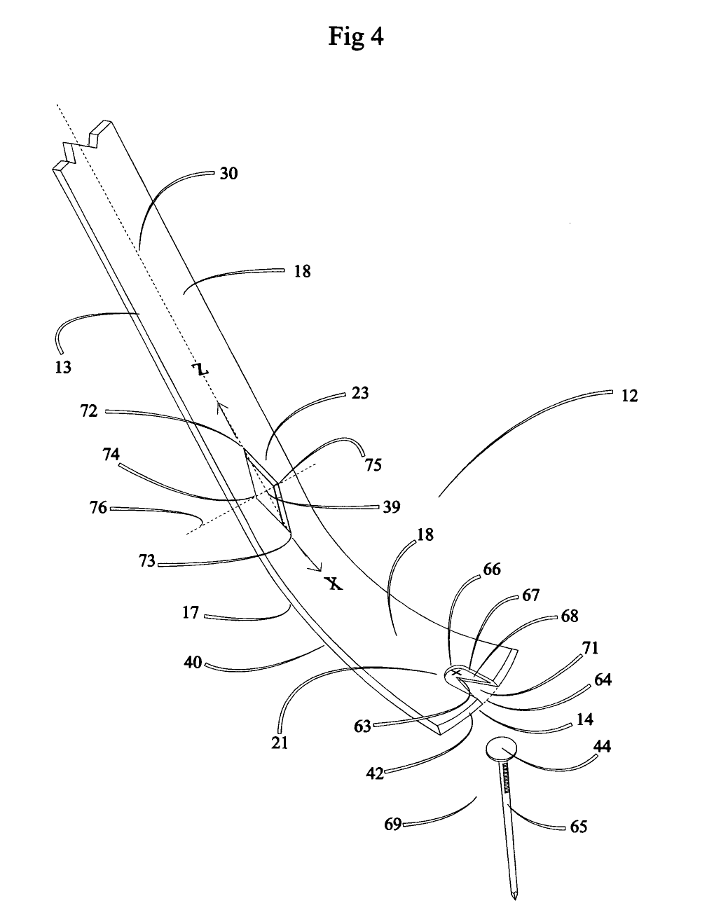

Reduction of thickness of the two aforementioned areas along with approximate 20 degree bevel 42 on crown 14 and on staple pulling fingers 1,3,5 and 7 on foot 11 of tool 10 facilitate easier manipulation of spike and nail puller 21 and easier positioning of staple pulling fingers 1,3,5 and 7 when pulling or removing either spikes and nails (see FIG. 4) or staples (see FIG. 3)

Referring now to FIG. 3 showing top angle view of foot 11 of tool 10 to illustrate detailed staple and nail pulling geometry of tool 10 whereby staple pulling fingers 1,3,5 and 7 and staple clearance notches 2,4 and 6 define said geometry. ( It should be noted that clearance notch 4 is also a component of nail puller 22) Each of the four staple pulling fingers 1,3,5 or 7 measures approximately 0.250″ in width and 0.375 in length as dictated by depth 53 of clearance notches 2,4, and 6. The afore mentioned geometry provides dimensioning for each or any individual staple pulling finger 1,3,5 or 7 to be positioned under staple bridge 47 and between staple legs 48 of industry standard ¼″ staples 51. Additionally, the 0.250 width of each individual staple pulling finger 1,3,5 or 7 in conjunction with 0.250″ width 54 of each of the clearance notches 2,4 and 6 allows for any two adjacent staple fingers 1,3,5, or 7 to be placed under bridge 47 and substantially between staple legs 48 for removing industry standard 1″ staples 52. Each of the staple pulling fingers 1,3,5 and 7 are provided with an approximate 20 degree bevel 43 on the outermost tip to facilitate easier placement of staple pulling fingers 1,3,5 or 7 under staple bridge 47 for pulling.

Continuing to reference FIG. 3, Nail puller 22 , integral to clearance notch 4 of foot 11 of tool 10 provides additional versatility for foot 11 in pulling nails 55. Nail puller 22 comprises a“V” shaped groove 4a arranged for receiving stem 56 of nail 55.

Relief, 57 of nail puller 22 provides clearance for nail head 58, and land 59 provides the base for relief 57 providing for substantial containment of nail head 58 when “V” shaped groove 4a of foot 11 is positioned under head 58 of nail 55 and substantially adjacent to nail stem 56 in preparation for pulling nail 55. Nail head relief 57 to measure approximately ½″″ diameter and 0.040″ deep with center point 60 to be approximately ⅝″ from extreme end 61 of foot 11 of tool 10. Center point 60 also to define point where sides of “V” shaped groove converge.

Note: Referencing FIG. 3a showing a side and front view of foot 11 of tool 10 wherein optional geometry is outlined for nail puller 22 and the two center staple pulling fingers 3 and 5 wherein fingers 3 and 5 are bent slightly downward (see standard position 43-S) toward base 15 of foot 11 (see optional position 43-O ) resulting in an offset of staple pulling fingers 3 and 5 approximately ⅛″ 80 below staple pulling fingers 1 and 7 for the purpose of easier insertion of nail puller 22 or staple pulling fingers 3 and 5 under nail head 58 or staple bridge 47 by allowing center area of foot 11 to make contact with surface immediately under fastener to be removed before fingers 1 and 7 of foot 11 make contact with work surface 100. With the exception of the slight offset bend to fingers 3 and 5 as outlined herein, all other details of foot 11 of tool 10 remain as previously outlined.

Referring now to FIG. 4 showing spike and nail puller 21 on grip end 12 and diamond notch nail puller 23 detail of tool 10 wherein spike puller 21 is comprised of a “V” groove 71 with “V” groove center 63 being approximately ⅝″ from line extending across open end 64 of “V” groove 63 measured from base of bevel 42 on crown 14 of tool 10 and wherein “V” notch open end 64 is approximately ⅝″ across. Relief 66 with a depth 67 of approximately 0.040″ from surface 18 to land 68 is provided for further decreasing the overall thickness of foot print 40 of spike puller 21 of tool 10 allowing for easier positioning of open end 64 of spike and nail puller 21 under head 44 in preparation for pulling. Relief 66 geometry is generally rectangular with one open end 64, and one radius end approximately 5/16″. Radius of relief 66 to be generated from a center common with “V” groove 71 center 63.

Diamond notch nail puller 23 is provided for pulling nails or spikes of extended length and is punched or otherwise formed substantially through shank 13 at a point outlined previously in detailed description referencing drawings FIGS. 2a and 2b.

Geometry of nail puller 23 is defined by minor axis 76 which is approximately ½″ in length measured between points 74 and 75, and major axis defined by points 72 and 73 measuring approximately 1.0″ there between. Points 72 and 73 to be on centerline 30 of shank 13 of tool 10. Diamond shaped geometry of nail puller 23 allows operator the option to use a pushing motion in the X direction locking nail stem 65 into point 72 or a pulling motion in the Z direction locking nail stem 65 into point 73 prior to pulling.

Note: Spike and nail puller 21 and diamond shaped nail puller 23 are commonly used in conjunction with each other, and spike 69 description numbers are referenced for both pullers in following descriptions of operation for tool 10 outlined in 5b and 5c

Referring now to FIG. 5a, illustrating the operation of tool 10 staple and nail pulling capability wherein bevel 43 on extreme end 61 of staple pulling fingers 1,3,5 or 7 of foot 11 are placed under bridge 47 of staple 51 or 52 where base 15 of foot 11 is substantially adjacent to work surface 100 and shank 13 of tool 10 is approximately at 97 degrees to work surface 100 wherein force 62 is applied in a backward direction to front 17 of grip 12 end of tool 10 causing tool 10 to rotate about rocker 29 on foot 11 end of tool 10 thus lifting staple pulling fingers 1,3,5 or 7 and extracting staple 51 or 52 from work surface 100. The aforementioned procedure also applies when utilizing nail puller 22 on foot 11 end of tool 10 wherein bevels 43 on ends of adjacent staple pulling fingers 3 and 5 are forced between nail head 58 (see FIG. 3) and work surface 100 to a point where nail stem 56 is substantially seated within the confines of “V” shaped groove in nail puller 22 where by applying force 62 as outlined above, extracts nail 55 from work surface 100

Referring now to FIG. 5b outlining operational description of spike and nail puller 21 wherein “V” notch 63 of spike puller 21 located on grip end 12 of tool 10 is forced substantially under head 44 of spike 65 between underside of head 44 and work surface 100, and wherein a downward force 62 is applied to back 18 surface approximately in rocker 29 area of tool 10. Functioning as a class 1 lever, tool 10 pivots around fulcrum 28 on back 17 face of shank 13 on tool 10 forcing upper side of land 68 (see FIG. 3) of spike and nail puller 21 substantially against underside of spike head 44 lifting and extracting spike 69 from work surface 100 to a point where procedure outlined for FIG. 5a can be employed when required to complete extraction of the nail. Diamond notched nail puller 23 can be implemented to complete removal of spike 69 as follows.

Referring to FIG. 5c outlining the operational view of diamond notched nail puller 23 of tool 10 providing a means for the removal of longer or heavier nails or spikes.

Subsequent to spike head 44 being lifted from work surface 100 using spike and nail puller 21 as outlined in description referring to FIG. 5b, diamond notch nail puller 23 is positioned over spike head 44 with back surface 18 of shank 13 facing up. Griping tool 10 on the underside or front 17 of the foot 11 end, shank 13 of tool 10 is manipulated in either the X direction or the Z direction engaging stem 65 of nail or spike 69 into either of the two “V” grooves as indicated by points 72 or 73 which also define the major axis of diamond notch nail puller 23. With foot print area 40 firmly adjacent to work surface 100 a lifting force 70 is applied to the underside of foot 11 approximately in the area adjacent to fulcrum 29 allowing tool 10 to be operated as a class two lever pivoting around fulcrum 28 on front 17 side of grip end 12 of tool 10, providing force to underside of spike head 44 and allowing nail or spike 69 to be extracted from work surface 100

It will be clear from the foregoing illustrations and description that the present invention demonstrates improved versatility in a roofing tool wherein a multiple of nail and staple removal capabilities are combined into one simple tool.

Although the present invention is described outlining particular embodiments, other variations, modifications or uses will become apparent by those skilled in the art. It is the inventors intention therefore, that the present invention not be limited by the specific disclosure of the embodiments therein, but by the scope of the appended claims.

1) A universal staple and nail-pulling tool comprised of an elongated flat bar having predetermined cross section including a length, a width, and a thickness wherein said flat bar comprises a shank defining the longitudinal axis, wherein a first end comprises an integral U-shaped rocker defining a fulcrum for a primary prying foot which is comprised of a four staple engaging fingers, and wherein a second end comprises a large radius bend defining a second fulcrum and secondary prying surface with said primary prying foot and secondary prying surface being provided for with integral V-groove nail puller geometry, and wherein said shank contains nail puller detail comprising a hole of diamond shaped geometry formed substantially through said thickness of said shank of said universal staple and nail pulling tool.

2) The universal staple and nail pulling tool of claim 1 wherein said plurality of staple engaging fingers in said primary prying foot are formed by geometry including clearance notches whereby each said staple engaging finger measures 0.250″ in width and each said clearance notch measures 0.250″ in width.

3) The universal staple and nail pulling tool of claim 2 wherein each of the four said staple engaging fingers arranged on said primary prying foot are beveled on their outermost edge facilitating easier placement under staple bridge.

4) The universal staple and nail pulling tool of claim 3 wherein two center said Staple engaging fingers on said primary prying foot are bent downward or otherwise displaced toward base of said primary prying foot.

5) A staple and nail removal tool comprised of an “L” shaped flat bar having a length, a width, and a thickness wherein the major longitudinal axis of said “L” shaped flat bar defines a shank and the base of said “L” shaped flat bar defines a prying foot wherein said prying foot of said staple and nail removal tool is provided with a “V” groove nail pulling detail intrigal to a plurality of staple pulling fingers and wherein a segment of said longitudinal axis of said flat bar which defines said shank is radiused in a plane parallel to said longitudinal axis with said radius defining a fulcrum used in conjunction with a secondary nail pulling detail.

6) The staple and nail removal tool of claim 5 wherein major longitudinal axis of said “L” and said prying foot on said base of said “L” intersect at an angle of approximately 97 degrees.

7) The staple and nail removal tool of claim 6 wherein width of said base of said prying foot is gradually increased to form a wider footprint starting from the approximate point of intersect between said major longitudinal axis and said prying foot and continuing to the extreme end of said prying foot and wherein width of said shank of said longitudinal axis gradually increases to form a wider footprint for said secondary nail pulling detail starting at a point approximately 10½″ from said base of said “L” and continuing to said secondary nail pulling detail on end of said major longitudinal axis of said “L” shaped flat bar.

8) The staple and nail removal tool of claim 7 wherein thickness dimension of said base of said prying foot is gradually reduced starting from said point of intersect between said major longitudinal axis and said prying foot and tapering down to approximately 50% of said thickness at said extreme end of said prying foot and wherein thickness of said shank of said staple and nail removal tool is reduced starting at point approximately 10½″ from said base and tapering to approximately 50% of said thickness at end of said major longitudinal axis of said “L” shaped flat bar.

9) A nail and staple removing tool comprising an elongated flat steel bar defines an “L” shaped shank having a cross sectional dimension of approximately 1¼″ wide and ¼″ thick wherein said flat steel bar has a front face, a back face, a grip end an integral rocker portion and a foot end wherein said “L” shape in combination with said rocker serves as a fulcrum for the staple pulling foot and wherein said rocker is formed by the intersecting geometry of two opposing radius' which substantially join said foot end to said grip end of said shank and wherein said grip end of said shank contains a “V” grooved nail puller at it's extreme end and whereby portion of said grip end is formed to a large diameter radius defining a fulcrum used in conjunction with said “V” grooved nail puller and wherein said foot end of said nail and staple removing tool comprises a combination nail and staple pulling detail whereby a “V” grooved nail puller is an integral part of said plurality of staple pulling fingers.
